(19) United States
(12) Patent Application Publication
(10) Pub. No.: US 2019/0056831 A1
(43) Pub. Date: Feb. 21, 2019

(54) DISPLAY PANEL DETECTING DEVICE

(71) Applicants: Boe Technology Group Co., Ltd., Beijing (CN); Ordos Yuansheng Optoelectronics Co., Ltd., Ordos (CN)

(72) Inventors: Yuan Liu, Beijing (CN); Long Wang, Beijing (CN); Zhaolei Li, Beijing (CN); Tuan Liang, Beijing (CN); Shuanghui Zhao, Beijing (CN); Xinhua Pei, Beijing (CN); Yuanda Cheng, Beijing (CN)

(21) Appl. No.: 15/956,726

(22) Filed: Apr. 18, 2018

(30) Foreign Application Priority Data
Aug. 16, 2017 (CN) 201721030201.1

(51) Int. Cl. G06F 3/041; G06F 3/0354; G06F 3/044; G06F 1/16

(52) U.S. Cl. CPC G06F 3/0412; G06F 1/169; G06F 3/044; G06F 3/03545

(57) ABSTRACT

A display panel detecting device is provided which includes a base, a fixing structure for mounting a display panel to be detected being on the base; a backlight source for providing backlight to the display panel to be detected, the backlight source being on the base; an information storage module; and a touch sensing device adapted to cover the display panel to be detected, and adapted to collect touch sensing information concerning a touch action being applied thereon and to send touch sensing information to the information storage module.

### CROSS-REFERENCE TO RELATED APPLICATION

This application claims the benefit of Chinese Patent Application No. 201721030201.1 filed on Aug. 16, 2017 in the State Intellectual Property Office of China, the whole disclosure of which is incorporated herein by reference.

### TECHNICAL FIELD

The present disclosure relates to a technical field of display panel detection, and in particular, to a display panel detecting device.

### BACKGROUND

When an operator uses a display panel detecting device in the related art to test a display panel, names of respective defects are usually written on a piece of dustless paper.

### SUMMARY

According to an aspect of the present disclosure, there is provided a display panel detecting device, comprising a base, a fixing structure for mounting a display panel to be detected being on the base; a backlight source for providing backlight to the display panel to be detected, the backlight source being on the base; an information storage module; and a touch sensing device adapted to cover the display panel to be detected, and adapted to collect touch sensing information concerning a touch action being applied thereon and to send touch sensing information to the information storage module.

In an embodiment of the present disclosure, the touch sensing device comprises a touch pen and a touch screen, and the touch pen is configured to mark defect information and form touch sensing information on the touch screen; the touch screen is configured to cover the display panel to be detected, and further configured to collect the touch sensing information and send the touch sensing information to the information storage module.

In an embodiment of the present disclosure, the fixing structure is a mounting groove on an upper surface of the base, the display panel to be detected being adapted to be fit in the mounting groove, and the backlight source being on a bottom wall of the mounting groove.

In an embodiment of the present disclosure, the display panel detecting device further comprises an upper polarizer and a lower polarizer, the upper polarizer and the lower polarizer being respectively above and below the display panel to be detected and forming a polarization angle with each other.

In an embodiment of the present disclosure, the upper polarizer is on the base and is flippable between an open position for opening the mounting groove and a detecting position for capping the mounting groove, the touch screen being on the upper polarizer, and wherein in a condition that the upper polarizer is at the detecting position and the display panel to be detected is mounted in the mounting groove, the touch screen and the upper polarizer cover the display panel to be detected; and the lower polarizer is in the mounting groove, in a condition that the display panel to be detected is mounted in the mounting groove, the lower polarizer is below the display panel to be detected and forms a polarization angle with the upper polarizer.

In an embodiment of the present disclosure, the upper polarizer is mounted on the upper surface of the base by a hinge structure.

In an embodiment of the present disclosure, the touch screen is an infrared touch sensing touch screen, a capacitive touch sensing touch screen or a resistive touch sensing touch screen.

In an embodiment of the present disclosure, the display panel detecting device further comprises a code scanning device for reading an ID number on the display panel to be detected, the code scanning device being on the base and being connected to the information storage module.

In an embodiment of the present disclosure, the display panel detecting device further comprises a display device for displaying the ID number on the display panel to be detected, the display device being on the base and being connected to the code scanning device.

In an embodiment of the present disclosure, the display panel detecting device further comprises a PCB being on the base and being movable between a pressing position for pressing against the display panel to be detected and an avoidance position for giving way to the display panel to be detected, the code scanning device being on the PCB, and wherein the PCB is electrically connected to the display panel at the pressing position and is electrically disconnected from the display panel at the avoidance position.

In an embodiment of the present disclosure, the information storage module is on the base.

In an embodiment of the present disclosure, the touch pen is detachably on the base.

In an embodiment of the present disclosure, the base comprises an inclined table surface, and the fixing structure, the backlight source, and the touch sensing device are all on the table surface.

### BRIEF DESCRIPTION OF THE DRAWINGS

The above and/or additional aspects and advantages of the present disclosure will become apparent and easily understood from the following description of embodiments in conjunction with the accompanying drawings, in which:

FIG. 1 is a schematic diagram of a structure of a display panel detecting device according to an embodiment of the present disclosure; and

FIG. 2 is another schematic diagram of the structure of the display panel detecting device according to an embodiment of the present disclosure.

### DETAILED DESCRIPTION OF PREFERRED EMBODIMENTS

Embodiments of the present disclosure are described in detail below, and are illustrated in the accompanying drawings, in which same or similar reference numerals denote same or similar elements or elements having same or similar functions throughout. The embodiments described below with reference to the accompanying drawings are exemplary, which are used only for explaining the present disclosure and should not be construed as limiting the present disclosure.

According to a general inventive concept of the present disclosure, there is provided display panel detecting device, comprising a base, a fixing structure for mounting a display panel to be detected being on the base; a backlight source for providing backlight to the display panel to be detected, the backlight source being on the base; an information storage module; and a touch sensing device adapted to cover the display panel to be detected, and adapted to collect touch sensing information concerning a touch action being applied thereon and to send touch sensing information to the information storage module. The display panel detecting device according to an embodiment of the present disclosure has advantages such as ease of use, high accuracy, and high work efficiency.

The display panel detecting device 1 according to an embodiment of the present disclosure will be described below with reference to the drawings.

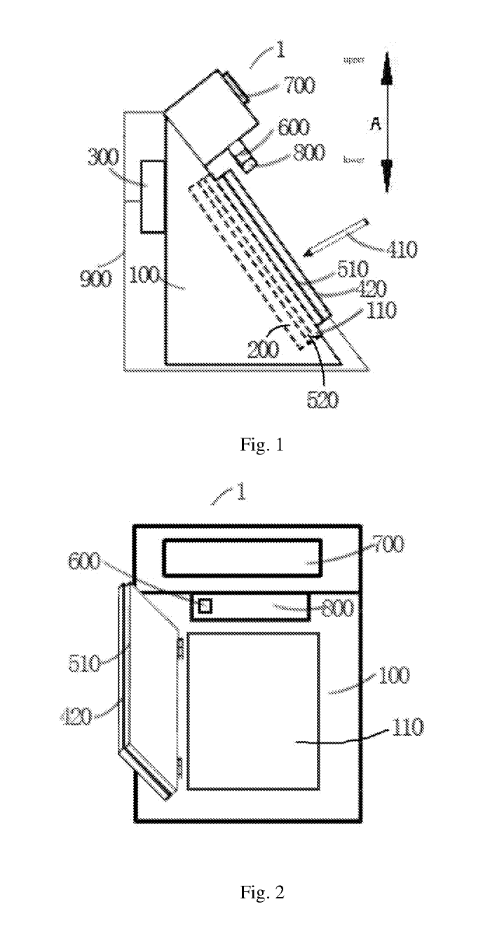

FIGS. 1 to 2 show a display panel detecting device 1 according to the present disclosure. As shown in FIGS. 1 to 2, a display panel detecting device 1 according to an embodiment of the present disclosure includes a base 100, a backlight source 200, an information storage module 300, and a touch sensing device.

A fixing structure for mounting the display panel to be detected is provided on the base 100. The backlight source 200 is used to provide backlight for the display panel to be detected, and the backlight source 200 is provided on the base 100. The information storage module 300 is provided on the base 100. The touch sensing device is adapted to cover the display panel to be detected, and the touch sensing device is adapted to collect touch sensing information concerning touch action being acted thereon and send it to the information storage module 300.

Specifically, touch sensing information includes, but is not limited to, position information, displacement information, and the like. In this way, when it is found by the operator that there is a defect on the display panel to be detected, the operator may directly mark the corresponding position of the sensing device by touching the touch sensing device, so that a piece of defect information concerning such a defect on the display panel to be detected may be recorded.

According to the display panel detecting device 1 of the embodiment of the present disclosure, by providing the touch sensing device, the touch sensing device may be used to input the defect information of the touch panel to be detected. Specifically, the defect information includes but is not limited to the position, size and color information of the defect and so on. In this way, defect information may be recorded in detail, which facilitates the generation, transmission, retrieval, and matching of information, facilitates intellectualized generation of information, electronic information flow, high efficiency in information retrieval and matching, facilitates data statistics and analysis, and facilitating information management and sharing, improving the level of intelligence and automation of the display panel detecting device 1. At the same time, it contributes to diminish the defects of the display panel to be detected and improve production quality of the display panel to be detected.

In addition, the display panel detecting device of the present disclosure records the defect information of the display panel to be detected by providing the touch sensing device, which may avoid error data due to manual recordation by operator and prevents from complicating the data processing by human factors, thereby accurately and completely recording the defect information. Therefore, it improves accuracy and reliability of input of the defect information as well as the working reliability and stability of the display panel detecting device.

In addition, as the display panel detecting device of the present disclosure is provided with the touch sensing device, without relying on manual recordation of the defect information by an operator, which may reduce the workload of the operator, improve the efficiency of information recording, save the operator's time and effort, and thus is convenient for an operator to use it and improve the operator's operating efficiency and experience.

Further, the display panel detecting device of the present disclosure is provided with an information storage module 300. As such, it is not required to use the way to record on dustless paper, which not only facilitates the storage of the defect information and improves the reliability and stability of data storage, but also eliminates use of dustless paper. The cost waste and environmental pollution are thus avoided which is caused by the fact that the dustless paper is unrecyclable, and needs to be disposed of at regular intervals, thereby contributing to reduce the usage cost of display panel detecting device 1, and to save resources so as to protect the environment.

Therefore, the display panel detecting device 1 according to an embodiment of the present disclosure has advantages such as ease of use, high accuracy, and high work efficiency.

Specifically, as shown in FIG. 1, the touch sensing device includes a touch pen 410 and a touch screen 420. The touch pen 410 is detachably disposed on the base 100. The touch screen 420 is adapted to cover the display panel to be detected, and the touch screen 420 collects touch information concerning touch action applied by the touch pen 410 on the touch screen 420 and sends it to the information storage module 300. In this way, the operator may mark the defect information concerning the defect on the touch screen 420 with the touch pen 410, which is not only convenient for the operator to use it, but also facilitates the recording and storage of the information on the display panel to be detected, and improves the operational reliability of the display panel detecting device.

More specifically, the fixing structure is a mounting groove 110 formed on an upper surface of the base 100 (both upper direction and lower direction are indicated by an arrow A in FIG. 1), and the display panel to be detected is adapted to be fit in the mounting groove 110. The backlight source 200 is provided on the bottom wall of the mounting groove 110. It facilitates mounting and fixing of the display panel to be detected, and facilitates the improvement of the mounting stability of the display panel to be detected. At the same time, it is convenient to provide backlight to the display panel to be detected.

Further, as shown in FIG. 1, the display panel detecting device 1 further includes an upper polarizer 510 and a lower polarizer 520. The upper polarizer 510 is disposed on the base 100 and is provided to be flippable between an open position for opening the mounting groove 110 and a detecting position for capping the mounting groove 110. The touch screen 420 is disposed on the upper polarizer 510. When the upper polarizer 510 is at the detecting position and the display panel to be detected is installed in the mounting groove 110, the touch screen 420 and the upper polarizer 510 cover the display panel to be detected. The lower polarizer 520 is installed in the mounting groove 110. When the display panel to be detected is installed in the mounting groove 110, the lower polarizer 520 is located below the display panel to be detected and forms a polarization angle with the upper polarizer 510. Specifically, the upper polarizer 510 and the lower polarizer 520 form the polarization angle for defect detection. It further facilitates arrangement of the display panel to be detected, and facilitates the defect detection on the display panel to be detected.

Further, as shown in FIG. 1, the upper polarizer 510 is mounted on the upper surface of the base 100 by a hinge structure. In this way, by flipping the upper polarizer 510, the upper polarizer 510 is switched between the open position for opening the mounting groove 110 and the detecting position for capping the mounting groove 110, which facilitates installation and detection of the display panel to be tested and facilitates the operator's operation.

For example, the touch screen 420 may be an infrared touch sensing touch screen, a capacitive touch sensing touch screen or a resistive touch sensing touch screen. In this way, the position and displacement of the display panel to be detected may be accurately recorded, and the accuracy and reliability of the display panel detecting device 1 may be improved.

As shown in FIG. 1, the display panel detecting device 1 further includes a code scanning device 600 for reading an ID number on the display panel to be detected. The code scanning device 600 is disposed on the base 100 and is connected to the information storage module 300. Specifically, the code scanning device 600 is disposed on a PCB 800. The ID number on the display panel to be detected is an identification number for distinguishing among each of the display panels to be detected. In this way, it is possible to prevent data errors caused by a visual inspection on the ID number by the operator, thereby improving the reading accuracy to the ID number of the display panel detecting device 1. Further, the defect information may be directly corresponded to the ID number, thereby clearly distinguishing the defect information concerning defect(s) on each of the display panels to be detected and avoiding confusion caused by manual records.

Specifically, as shown in FIG. 1, the display panel detecting device 1 further includes a display device 700 configured to display an ID number on the display panel to be detected. The display device 700 is disposed on the base 100 and is connected to the code scanning device 600. It facilitates the display of the ID number on the display panel to be detected, and facilitates the operator's reading of the ID number on the display panel to be detected.

For example, as shown in FIG. 1 and FIG. 2, the display panel detecting device 1 further includes a PCB 800. The PCB is disposed on the base 100 and is movable between a pressing position for pressing against the display panel to be detected and an avoidance position for giving way to the display panel to be detected. The code scanning device 600 is disposed on the PCB 800. When the PCB 800 is at the pressing position, the PCB 800 is electrically connected to the display panel to be detected so as to establish a signal transmission therebetween. When the PCB 800 is at the avoidance position, the PCB 800 is disconnected from the display panel to be detected. Specifically, as shown in FIG. 1, the display device 700, the code scanning device 600, and the touch sensing device are interconnected via a cable 900. It facilitates the transmission of data and facilitates improvement of the working efficiency of the display panel detecting device 1.

The operation of the display panel detecting device 1 according to an embodiment of the present disclosure will be described below with reference to the drawings.

When the display panel detecting device 1 is working, the backlight source 200 is turned on, the display panel to be detected is placed on the base 100, and the PCB 800 is pressed down. The upper polarizer 510 with a touch screen 420 caps the mounting groove 110. The display panel detecting device 1 reads and displays the ID number of the display panel to be detected through the code scanning device 600 and the display device 700. The operator uses the touch pen 410 to click, approach to, or slide on the touch panel 420 after detecting a defect, such that information such as location, color, and size of the defect is automatically uploaded to the information integration system through the information storage module 300.

Specifically, the touch screen may be set as a 9-square grid or a 12-square grid according to actual needs, which facilitates a regular tracking to the defect and improves the working efficiency of the display panel detecting device 1. The information integration system stores information through a CIM system. Different access subsystems may access any information from the CIM system for data processing or matching of defect information with the equipment.

Other configurations and operations of the display panel detecting device 1 according to the embodiment of the present disclosure are known to those skilled in the art and will not be described in detail herein.

In the description of the present disclosure, it should be noted that the terms “install”, “mount” and “connected” should be understood in a broad sense unless specifically defined or limited otherwise, and may be, for example, a fixed connection or a detachable connection, or an integral connection; may be a mechanical connection or an electrical connection; they may be a direct connection or an indirect connection through an intermediate medium, may be an internal communication of two elements. For those skilled in the art, the specific meanings of the above terms in the present disclosure may be understood in specific situations.

In the description of the present specification, the descriptions referring to the terms “an embodiment”, “some embodiments”, “examples” and the like mean that the specific features, structures, materials, or characteristics described in connection with the embodiment or example are included in at least one embodiment or example in the present disclosure. In at least one embodiment or example of the disclosure, the schematic representation of the above terms does not necessarily refer to the same embodiment or example, and the specific features, structures, materials, or characteristics described may be any one or more embodiments or examples which are combined in a suitable manner.

Although embodiments of the present disclosure have been shown and described, it will be apparent to those skilled in the art that various changes, modifications, substitutions, and variations may be made to these embodiments without departing from the principles and spirit of the present disclosure. The scope of the disclosure is defined by the claims and their equivalents.

What is claimed is:

1. A display panel detecting device, comprising
a base, with a fixing structure for mounting a display panel to be detected being on the base;
a backlight source for providing backlight to the display panel to be detected, the backlight source being on the base;
an information storage module; and
a touch sensing device adapted to cover the display panel to be detected, and adapted to collect touch sensing information concerning a touch action being applied thereon and to send touch sensing information to the information storage module.

2. The display panel detecting device according to claim 1, wherein:
the touch sensing device comprises a touch pen and a touch screen;
the touch pen is configured to mark defect information and form touch sensing information on the touch screen; and
the touch screen is configured to cover the display panel to be detected, and further configured to collect the touch sensing information and send the touch sensing information to the information storage module.

3. The display panel detecting device according to claim 2,
wherein the fixing structure is a mounting groove on an upper surface of the base, the display panel to be detected being adapted to be fit in the mounting groove, and the backlight source being on a bottom wall of the mounting groove.

4. The display panel detecting device according to claim 3,
wherein the display panel detecting device further comprises an upper polarizer and a lower polarizer, the upper polarizer and the lower polarizer being respectively above and below the display panel to be detected and forming a polarization angle with each other.

5. The display panel detecting device according to claim 4, wherein:
the upper polarizer is on the base and is flippable between an open position for opening the mounting groove and a detecting position for capping the mounting groove, the touch screen being on the upper polarizer, and wherein in a condition that the upper polarizer is at the detecting position and the display panel to be detected is mounted in the mounting groove, the touch screen and the upper polarizer cover the display panel to be detected; and
the lower polarizer is in the mounting groove, and in a condition that the display panel to be detected is mounted in the mounting groove, the lower polarizer is below the display panel to be detected and forms a polarization angle with the upper polarizer.

6. The display panel detecting device according to claim 5,
wherein the upper polarizer is mounted on the upper surface of the base by a hinge structure.

7. The display panel detecting device according to claim 2,
wherein the touch screen is an infrared touch sensing touch screen, a capacitive touch sensing touch screen or a resistive touch sensing touch screen.

8. The display panel detecting device according to claim 1,
wherein the display panel detecting device further comprises a code scanning device for reading an ID number on the display panel to be detected, the code scanning device being on the base and being connected to the information storage module.

9. The display panel detecting device according to claim 8,
wherein the display panel detecting device further comprises a display device for displaying the ID number on the display panel to be detected, the display device being on the base and being connected to the code scanning device.

10. The display panel detecting device according to claim 8,
wherein the display panel detecting device further comprises a PCB on the base and being movable between a pressing position for pressing against the display panel to be detected and an avoidance position for giving way to the display panel to be detected, the code scanning device being on the PCB, and wherein the PCB is electrically connected to the display panel at the pressing position and is electrically disconnected from the display panel at the avoidance position.

11. The display panel detecting device according to claim 1, wherein the information storage module is on the base.

12. The display panel detecting device according to claim 2, wherein the touch pen is detachably on the base.

13. The display panel detecting device according to claim 1, wherein the base comprises an inclined table surface, and the fixing structure, the backlight source, and the touch sensing device are all on the table surface.
